(19) United States
(12) Patent Application Publication
(10) Pub. No.: US 2009/0273874 A1
(43) Pub. Date: Nov. 5, 2009

(54) POWER SWITCH CIRCUIT EXHIBITING OVER CURRENT AND SHORT CIRCUIT PROTECTION AND METHOD FOR LIMITING THE OUTPUT CURRENT THEREOF

(75) Inventor: CHIH YUEH YEN, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: ADVANCED ANALOG TECHNOLOGY, INC., HSINCHU (TW)

(21) Appl. No.: 12/202,961

(22) Filed: Sep. 2, 2008

(30) Foreign Application Priority Data
Apr. 30, 2008 (TW) 097115829

(51) Int. Cl. H02H 9/02

(52) U.S. Cl. 361/93.9

(57) ABSTRACT

A power switch circuit exhibiting over current and short circuit protections comprises a power-driving unit, a sense unit and a feedback controller circuit. The power-driving unit provides power to a load circuit from a power supply. The sense unit senses the output current of the power-driving unit. The feedback controller circuit controls the power-driving unit and the sense unit. When the output current of the power-driving unit exceeds a threshold, the output current is limited to an over current protection current level. When the resistance of the load circuit is approximately zero, the output current of the power-driving unit is limited to a short circuit protection current level.

### BACKGROUND OF THE INVENTION

1. Field of the Invention

The present invention relates to a power switch circuit, and more particularly, to a power switch circuit with over current protection mechanism.

2. Description of the Related Art

A power switch circuit serves the function of transferring power from a power supply to a load circuit. For a constant voltage power source, the output current depends on the resistance of the load circuit. The power consumption of the power switch circuit is the product of the output voltage and the output current. To protect the load circuit or the power switch circuit from thermal damage due to excessive dissipated power, there exists a need for a power switch circuit with over current protection mechanism. U.S. Pat. No. 6,816,349 discloses a power switch circuit. As shown in FIG. 1, the power switch circuit 100 comprises a power transistor 110, a sense transistor 120, an operational amplifier 130 and resistors 140 and 141. The body of the power transistor 110 is grounded. The gate and source electrodes of the sense transistor 120 are respectively connected to the gate electrode of the power transistor 110 and to one end of the resistor 140, whose other end is grounded. The non-inverting input terminal of the operational amplifier 130 is connected to the source electrode of the sense transistor 120 and a reference voltage V_{ref}. The output terminal of the operational amplifier 130 is connected to the gate electrode of the power transistor 110 and the gate electrode of the sense transistor 120. The resistor 141 serves the function of activating a parasite capacitor of the sense transistor 120 such that the current through the power transistor 110 is reduced and thus achieves the objective of over current protection when a short circuit occurs at the output terminal. Disadvantages stem from the difficulty of controlling the body current of the sense transistor 120 because such current is determined primarily by the physical characteristics of the manufacturing process. In addition, the reference voltage V_{ref} increases the design requirement to the implementation of the power switch circuit 100.

U.S. Pat. No. 6,606,358 discloses a power switch circuit, as shown in FIG. 2. The power switch circuit 200 comprises a power transistor 210, a sense transistor 220, bipolar junction transistors 230 and 240, resistors 250 and 251 and current sources 260, 261, 262 and 263. The emitters of the bipolar junction transistors 230 and 240 are respectively connected to the source electrode of the sense transistor 220 and the source electrode of the power transistor 210 via the resistors 250 and 251 to sense the currents through the sense transistor 220 and the power transistor 210. The current sink 262 is required in the power switch circuit 200 to subtract the bias current through the bipolar junction transistors 230. The practicability of the power switch circuit 200 is significantly reduced because the high current gain bipolar junction transistor manufacturing technique is not available in most CMOS processes.

U.S. Pat. No. 5,422,593 discloses a power switch circuit. As shown in FIG. 3, the power switch circuit 300 comprises a power transistor 310, a sense transistor 320, a transistor 330, an operational amplifier 340, a driver circuit 350, resistors 360 to 364 and a voltage bias circuit 370. The operational amplifier 340 forms a feedback loop, locking the current through the power transistor 310 and the sense transistor 320, and delivering an output signal to the driver circuit 350 via the transistor 330. The driver circuit 350 pulls down the voltages at the gate electrode of the power transistor 310 and the gate electrode of the sense transistor 320 when the output current of the power transistor 310 exceeds a threshold. The resistors 363 and 364 serve to adjust the threshold current. However, controlling the voltage across the voltage bias circuit 370 is difficult due to the fact that such voltage varies with the output voltage of the power transistor 310.

### SUMMARY OF THE INVENTION

The power switch circuit exhibiting over current protection and short circuit protection mechanisms according to one embodiment of the present invention comprises a power-driving unit, a sense unit and a feedback controller circuit. The power-driving unit provides power to a load circuit from a power supply. The sense unit senses the output current of the power-driving unit. The feedback controller circuit controls the power-driving unit and the sense unit. The output current of the power-driving unit is limited to an over current protection current when it is over a threshold. Otherwise, the output current of the power-driving unit is limited to a short circuit protection current when the resistance of the load circuit is approximately zero ohm.

The power switch circuit exhibiting over current protection and short circuit protection mechanism according to another embodiment of the present invention comprises a power transistor, a first sense transistor, an amplifier circuit, a first current source, a second sense transistor and a second current source. The power transistor provides power to a load circuit from a power supply. The first sense transistor is connected to the power transistor. The amplifier circuit compares the output voltages of the power transistor and the first sense transistor to generate a corresponding current. The first current source provides current to the first sense transistor. The second sense transistor is connected to the power transistor, the first sense transistor and the amplifier circuit. The second current source provides current to the second sense transistor. The output current of the power-driving unit is limited to the product of the current provided by the first current source multiplied by the ratio of the width to length ratio (W/L) of the power transistor to the ratio of the width to length ratio of the first sense transistor when the load circuit is over a threshold value; otherwise, the current of the power-driving unit is limited to the product of the current provided by the second current source multiplied by the ratio of the width to length ratio (W/L) of the power transistor to the ratio of the width to length ratio of the second sense transistor when the resistance of the load circuit is approximately zero ohm.

The method for limiting the output current of a power switch circuit according to yet another embodiment of the present invention comprises the steps of: providing power to a load circuit from a power supply by the power switch circuit; limiting the output current of the power switch circuit to an over current protection current level if the resistance of load circuit is smaller than a threshold; and limiting the output current of the power switch circuit to a short circuit protection current level if the resistance of the load circuit is substantially equal to zero ohm.

### BRIEF DESCRIPTION OF THE DRAWINGS

The objectives and advantages of the present invention will become apparent upon reading the following description and upon referring to the accompanying drawings of which:

FIG. 1 shows a block diagram of a power switch circuit disclosed in U.S. Pat. No. 6,816,349;

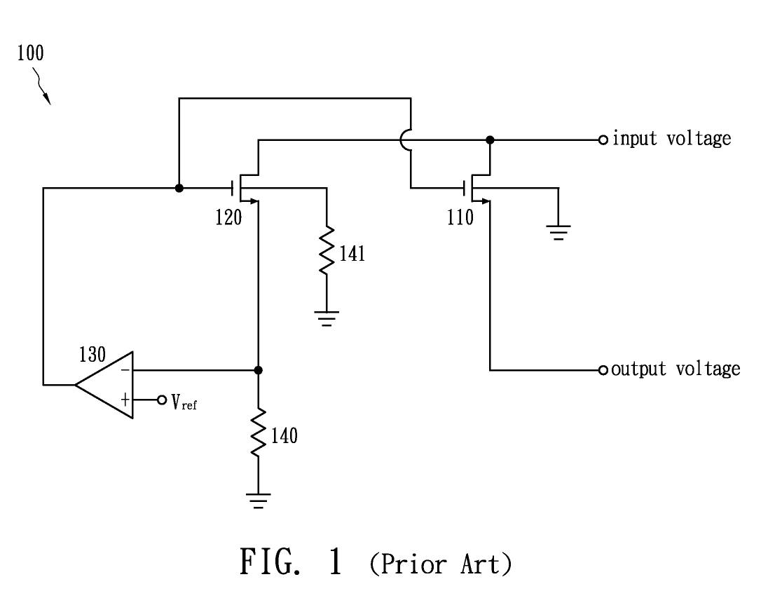

FIG. 2 shows a block diagram of a power switch circuit disclosed in U.S. Pat. No. 6,606,358;

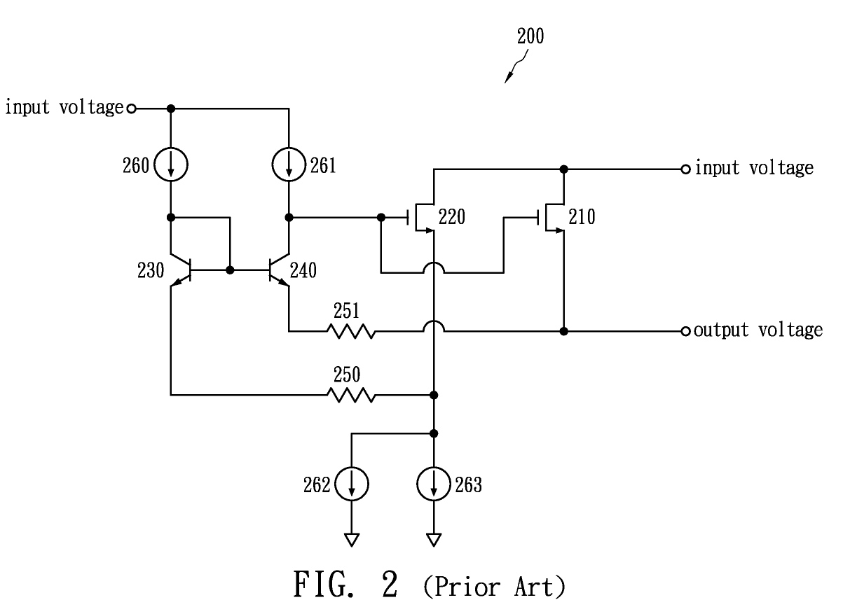

FIG. 3 shows a block diagram of a power switch circuit disclosed in U.S. Pat. No. 5,422,593;

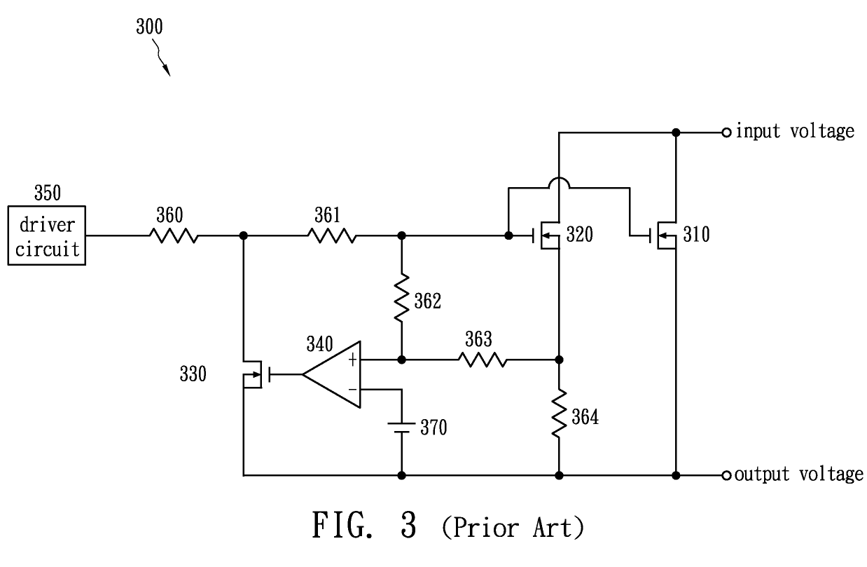

FIG. 4 shows a block diagram of the power switch circuit according to one embodiment of the present invention;

FIG. 5 shows a block diagram of the power switch circuit according to one embodiment of the present invention;

FIG. 6 shows a block diagram of the power switch circuit comprising a timing circuit according to one embodiment of the present invention;

FIG. 7 shows a block diagram of a conventional voltage to current amplifier;

FIG. 8 shows a block diagram of a conventional voltage to current amplifier; and

FIG. 9 shows a flow chart of the method for limiting the output current of a power switch circuit according to another embodiment of the present invention.

### DETAILED DESCRIPTION OF THE INVENTION

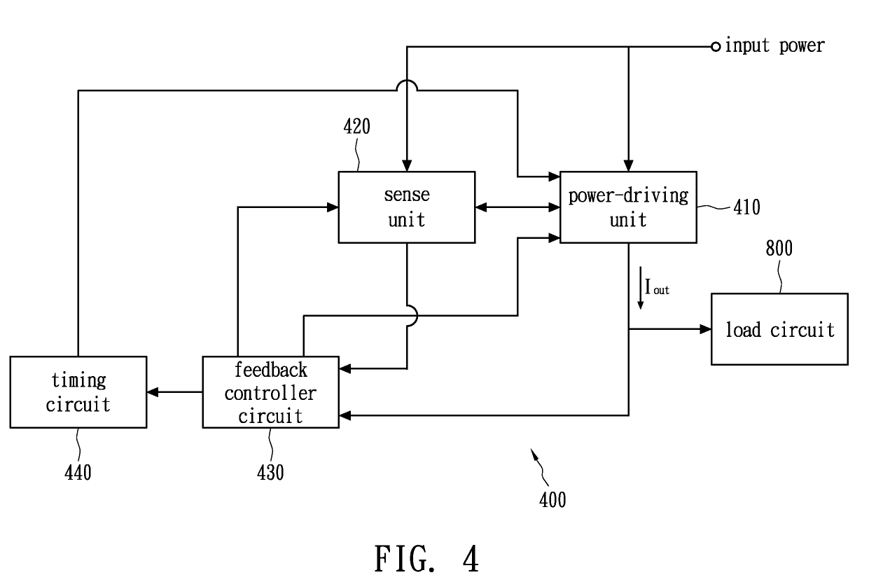

FIG. 4 shows a block diagram of the power switch circuit exhibiting over current protection and short circuit protection mechanism according to one embodiment of the present invention. The power switch circuit 400 comprises a power-driving unit 410 (e.g., a transistor), a sense unit 420 (e.g., a transistor) and a feedback controller circuit 430. The power-driving unit 410 provides power to a load circuit 800 from an input power supply. The sense unit 420 senses the output current Iₒᵤₜ of the power-driving unit 410. The feedback controller circuit 430 controls the power-driving unit 410 and the sense unit 420 in order to address any over current or short circuit situation in the load circuit 800. There are three modes the power switch circuit 400 can operate in: a normal mode, an over current protection mode and a short circuit protection mode. When the resistance of the load circuit 800 is smaller than a threshold, the output current Iₒᵤₜ is limited to an over current protection current level. When the resistance of the load circuit 800 is substantially equal to zero ohm, the output current Iₒᵤₜ is limited to a short circuit protection current level. Preferably, the short circuit protection current level is larger than the over current protection current level.

Preferably, the power switch circuit 400 can further incorporate a timing circuit 440 to detect the duration of the over current protection mode and the short circuit protection mode. When the period of time during which the output current Iₒᵤₜ of the power-driving unit 410 is limited to the over current protection current or the short circuit protection current exceeds a threshold, the timing circuit 440 outputs a signal to deactivate the power-driving unit 410.

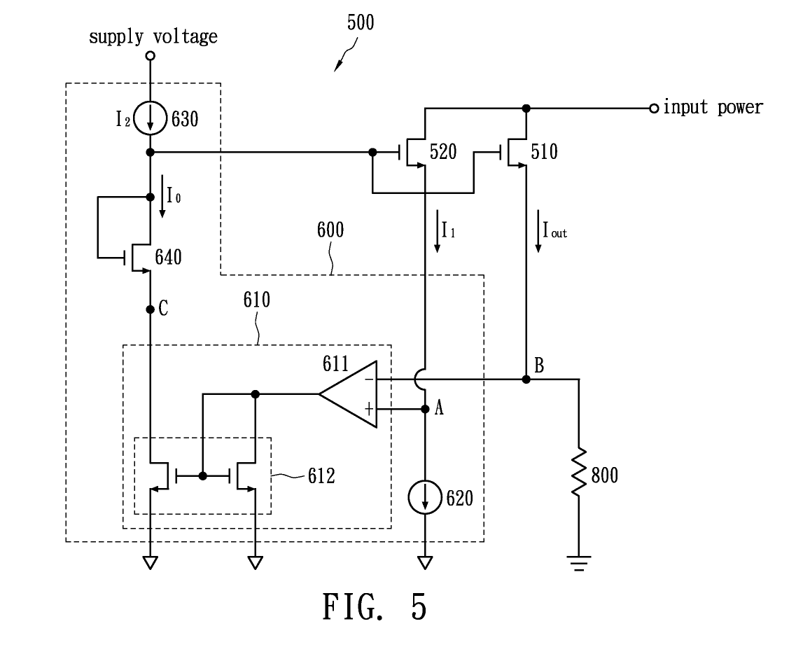

FIG. 5 shows a block diagram of the power switch circuit exhibiting over current protection and short circuit protection mechanisms according to another embodiment of the present invention. The power switch circuit 500 comprises a power transistor 510, a first sense transistor 520 and a feedback controller circuit 600. The drain and source electrodes of the power transistor 510 are respectively connected to a power source and a load circuit 800 such that the power transistor 510 connects the power source to the load circuit 800. The drain and gate electrodes of the first sense transistor 520 are respectively connected to the power source and the gate electrode of the power transistor 510.

The feedback controller circuit 600 controls the power transistor 510 and the first sense transistor 520 in order to address any over current or short circuit situation at the load circuit 800. The feedback controller circuit 600 comprises an amplifier circuit 610, a first current source 620, a second current source 630 and a second sense transistor 640. The first current source 620 is connected to the source electrode of the first sense transistor 520, and provides current to the first sense transistor 520. The drain and the gate electrodes of the second sense transistor 640 are connected to the drain and gate electrodes of the power transistor 510, respectively. The second current source 630 is connected to the drain electrode of the second sense transistor 640, and provides current to the second sense transistor 640. The amplifier circuit 610 compares the output voltages of the power transistor 510 and the first sense transistor 520 to generate a corresponding current, and controls the gate electrode of the power transistor 510 by the load formed by the generated current and the second current source 630. The input terminals of the amplifier circuit 610 are connected to the input current terminals of the power transistor 510 and the first sense transistor 520 respectively. The amplifier circuit 610 comprises a voltage to current amplifier 611 and a current mirror circuit 612. The input terminals of the voltage to current amplifier 611 are respectively connected to the source electrodes of the power transistor 510 and the first sense transistor 520, i.e., node A and B. When the voltage at node A is higher than that at node B, the voltage to current amplifier 611 outputs a current corresponding to the voltage difference of the input terminals of the current amplifier 611. When the voltage at node A is lower than that at node B, on the other hand, the output current of the current amplifier 611 is zero ampere. The current mirror circuit 612 is connected to the source electrode of the second sense transistor 640, and amplifies the output current of the voltage to current amplifier 611.

Preferably, the width to length ratios of both the first sense transistor 520 and the second sense transistor 640 are much smaller than that of the power transistor 510 (in the present embodiment, for example, both are is 1/10000 times smaller) to reduce the current through the power switch circuit 500. Since the current through the first sense transistor 520 is the current I₁ provided by the first current source 620, the voltage difference between node A and the gate electrode of the first sense transistor 520, i.e. the gate to source voltage of the first sense transistor 520, is a fixed value. On the other hand, since the width to length ratios of the power transistor 510 is 10000 times of that of the first sense transistor 520, when the current Iₒᵤₜ through the power transistor 510 is 10000 times the current through the first sense transistor 520 (Iₒᵤₜ=10000 I₁), the voltages at node A and B are regulated as an identical value.

There are three modes the power switch circuit 500 can operate in: a normal mode, an over current protection mode and a short circuit protection mode. When the power switch circuit 500 operates in the normal mode, that is, the resistance of the load circuit 800 is greater than a threshold, the current Iₒᵤₜ through the power transistor 510 is less than 10000 times the current I₁ and the voltage at node B is higher than that at node A. At such time, the output current of the voltage to current amplifier 611 is zero ampere, the current mirror circuit 612 is deactivated, the second current source 630 is also deactivated such that the voltage across it is zero volt, and the voltage at the gate electrodes of the power transistor 510 and the first sense transistor 520 is pulled up to a supply voltage VCC.

When the resistance of the load circuit 800 is below a threshold, the current Iₒᵤₜ through the power transistor 510 is supposed to be greater than 10000 times the current I₁ and the voltage at node B should be lower than that at node A, the power switch circuit 500 then operates in the over current protection mode. The output current of the voltage to current amplifier 611 is amplified by the current mirror circuit 612 into current I₀, which is stronger than the current I₂ provided by the second current source 630. As a result, the current Iₒ pulls down the voltage at the gate electrode of the power transistor 510 such that the current through the power transistor 510 drops, i.e., the current Iₒᵤₜ drops. When the current Iₒᵤₜ drops 15 to a point where the voltage at node B is slightly lower than that at node A, the power switch circuit 500 reaches a steady state. At such time, the current Iₒᵤₜ is 10000 times the current I₁. That is, the output current Iₒᵤₜ of the power switch circuit 500 is limited to 10000 times the current I₁ when it is in the over current protection mode.

When the resistance of the load circuit 800 continues to drop, the output current of the amplifier circuit 610 I₀ continues to pull down the voltage at node C, and the voltage at the gate electrodes of the power transistor 510 and the first sense transistor 520 continues to drop. Because the current I₁ through the first sense transistor 520 is a fixed value, the gate to source voltage of the first sense transistor 520 is fixed as well. Therefore, the voltage at node A also continues to drop. However, the output current of the power switch circuit 500 remains at 10000 times the current I₁.

When the output terminal of the power switch circuit 500 is grounded, i.e., the resistance of the load circuit 800 approaches zero ohm, the power switch circuit 500 enters the short circuit protection mode. At such point, the voltage at node A approaches zero volt, and the voltage at node C is also approaches zero volt. As a result, the first current source 620 is not in its normal mode such that the voltage across it is zero volt, and the current mirror circuit 612 is likewise not in its normal mode such that the voltage across it is also zero volt. Moreover, because the voltage at the source electrode of the second sense transistor 640 approaches zero volt, and the gate electrode of the second sense transistor 640 is connected to that of the power transistor 510, the second sense transistor 640 and the power transistor 510 form a current mirror circuit. As a result, the current through the power transistor 510 is 10000 times the current through the second sense transistor 640, i.e., the current Iₒᵤₜ is 10000 times the current I₂. Therefore, when the power switch circuit 500 is in the short circuit protection mode, the output current Iₒᵤₜ of the power switch circuit 500 is limited to 10000 times the current I₂.

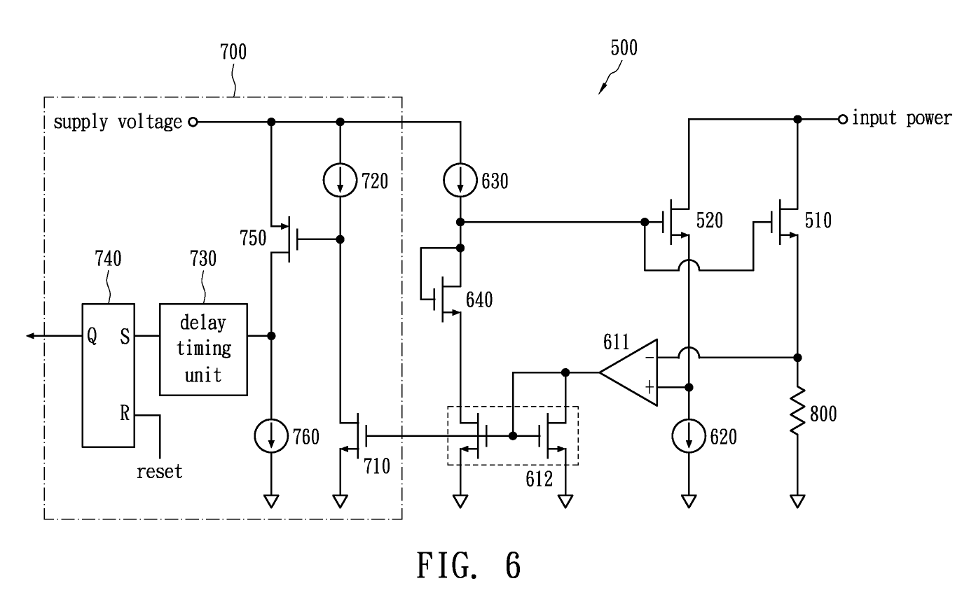

Preferably, the power switch circuit 500 can further incorporate a timing circuit 700, as shown in FIG. 6. The timing circuit 700 acts as the timing circuit 440, and comprises a third sense transistor 710, a third current source 720, a delay timing unit 730 and a latch 740. The third sense transistor 710 is connected to the current mirror circuit 612. The third current source 720 provides current to the third sense transistor 710. The delay timing unit 730 is connected to the third sense transistor 710. The latch 740 records the output of the delay timing unit 730. When the output current of the voltage to current amplifier 611 is not zero ampere, the third sense transistor 710 outputs a current protection signal. When the period of time during which the third sense transistor 710 outputs the current protection signal exceeds a threshold, the delay timing unit 740 outputs a current protection confirmation signal.

Preferably, the timing circuit 700 can further comprise a fourth sense transistor 750 and a fourth current source 760. The fourth sense transistor 750 is connected between the third sense transistor 710 and the delay timing unit 730 to amplify the output signal of the third sense transistor 710. The fourth current source 760 provides current to the fourth sense transistor 750. When the period of time during which the fourth sense transistor 750 outputs the enhanced current protection signal exceeds a certain time, the delay timing unit 730 outputs the current protection confirmation signal.

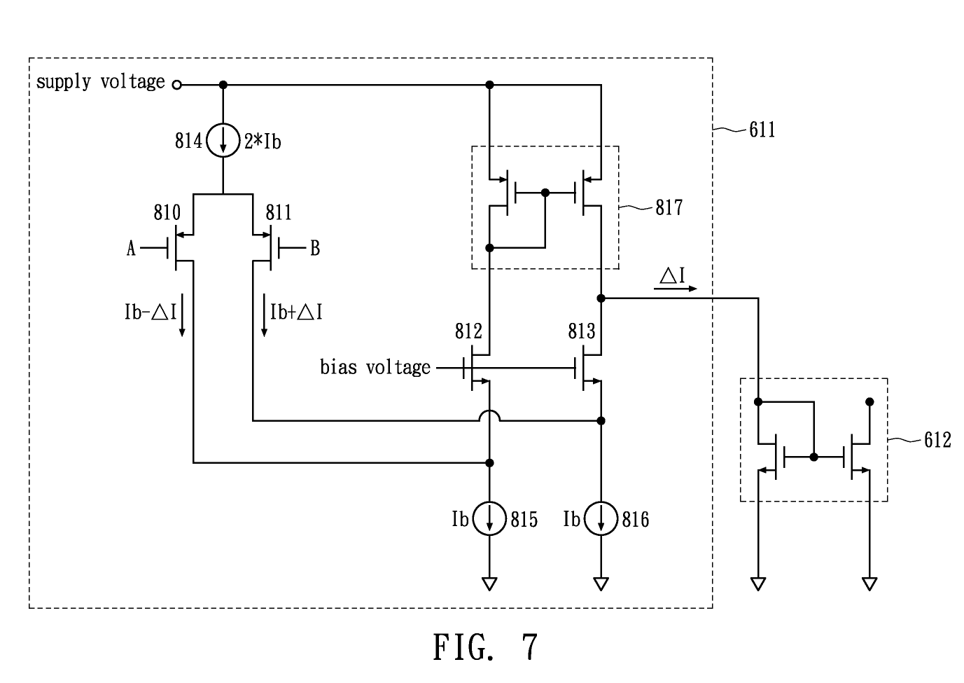

FIG. 7 shows a block diagram of a conventional voltage to current amplifier. The voltage to current amplifier 611 is connected to the current mirror circuit 612, and comprises transistors 810, 811, 812 and 813, current sources 814, 815 and 816, and a current mirror circuit 817. The current source 814 provides an output current 2I_{b}, while both the current sources 815 and 816 provide output current I_{b}. As shown in FIG. 7, when the voltage at A is higher than the voltage at node B, the currents through the transistors 811 and 810 are respectively I_{b}+ΔI and I_{b}−ΔI. At such time, the transistor 812 is active and the current flow is I_{b}+ΔI−I_{b}=ΔI. Moreover, because the transistor 813 is inactive, the output current of the voltage to current amplifier 611, which is mirrored by current mirror circuit 817, is ΔI.

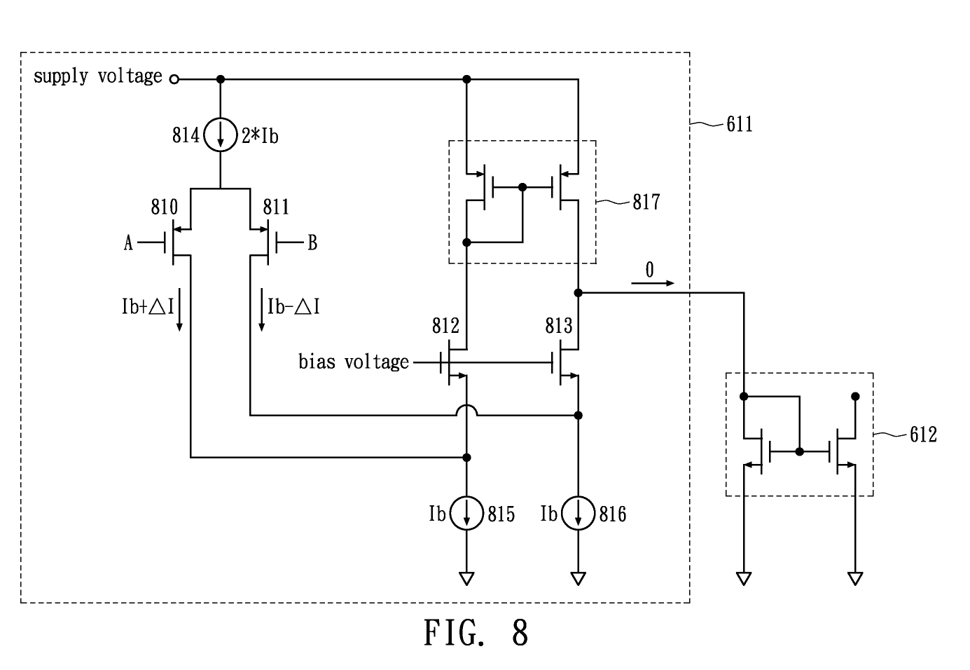

When the voltage at A is lower than the current at node B, as shown in FIG. 8, the currents through the transistors 811 and 810 are respectively I_{b}−ΔI and I_{b}+ΔI. At such time, the transistor 812 is inactive, there is no current mirrored by the current mirror circuit 817, and the output current of the voltage to current amplifier 611 is zero ampere.

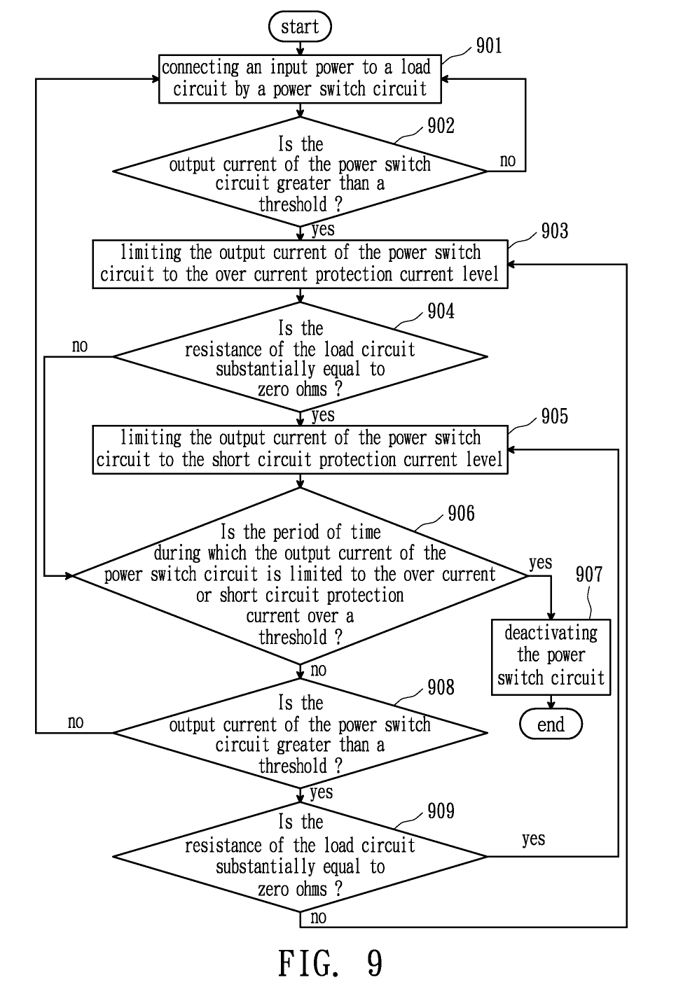

FIG. 9 shows a flow chart of the method for limiting the output current of a power switch circuit according to another embodiment of the present invention. In step 901, an input power is connected to a load circuit by a power switch circuit. In step 902, the output current of the power switch circuit is checked to determine whether it is above an over current threshold. If so, step 903 is executed; otherwise, step 901 is repeated. In step 903, the output current of the power switch circuit is limited to an over current protection current level. In step 904, the resistance of the load circuit is checked to determine whether it is substantially equal to zero ohm. If so, step 905 is executed; otherwise, step 906 is executed. In step 905, the output current of the power switch circuit is limited to a short circuit protection current level. In step 906, the period of time during which the output current of the power switch circuit is limited to either the over current protection current or the short circuit protection current is checked to determine whether such duration of time exceeds a threshold. If so, step 907 is executed; otherwise, step 908 is executed. In step 907, the power switch circuit is deactivated. In step 908, the output current of the power switch circuit is checked to determine whether it is greater than a threshold; if so, step 909 is executed; otherwise, step 901 is repeated. In step 909, the resistance of the load circuit is checked if it is substantially equal to zero ohm. If so, step 905 is repeated; otherwise, step 903 is repeated.

In conclusion, the power switch circuits of the embodiments of the present invention require no external reference voltage or embedded voltage bias circuit, and can be easily implemented in a monolithic integrated chip without any external components. These features overcome the disadvantages of the conventional power switch circuits previously mentioned. In addition, the power switch circuits of the embodiments of the present invention adopt two current protection modes, for which the mode switching is automatic, and thus are more flexible in any application.

The above-described embodiments of the present invention are intended to be illustrative only. Those skilled in the art may devise numerous alternative embodiments without departing from the scope of the following claims.

What is claimed is:

1. A power switch circuit exhibiting over current and short circuit protections, comprising:
a power-driving unit configured to provide power to a load circuit from a power supply;
a sense unit configured to sense the output current of the power-driving unit; and
a feedback controller circuit configured to control the power-driving unit and the sense unit;
wherein the output current of the power-driving unit is limited to an over current protection current level when it is over a threshold;
wherein the output current of the power-driving unit is limited to a short circuit protection current level when the resistance of the load circuit is about zero ohm.

2. The power switch circuit of claim 1, wherein the short circuit protection current level is greater than the over current protection current level.

3. The power switch circuit of claim 1, which further comprises a timing circuit, wherein when the period of time during which the output current of the power-driving unit is limited to either the over current protection current level or to the short circuit protection current level exceeds a certain time, the timing circuit outputs a signal to deactivate the power-driving unit.

4. A power switch circuit exhibiting over current and short circuit protections, comprising:
a power transistor configured to s provide power to a load circuit from a power supply;
a first sense transistor connected to the power transistor;
an amplifier circuit configured to compare the output voltages of the power transistor and the first sense transistor to generate a corresponding current;
a first current source configured to provide current to the first sense transistor;
a second sense transistor connected to the power transistor, the first sense transistor and the amplifier circuit; and
a second current source configured to provide current to the second sense transistor;
wherein when the output current of the power transistor is over a threshold, the output current of the power transistor is limited to the product of the current provided by the first current source multiplied by the ratio of the width to length ratio of power transistor to the ratio of the width to length ratio of the first sense transistor;
wherein when the resistance of the load circuit is about zero ohm, the output current of the power-driving unit is limited to the product of the current provided by the second current source multiplied by the ratio of the width to length ratio of power transistor to the ratio of the width to length ratio of the second sense transistor.

5. The power switch circuit of claim 4, wherein the drain and gate electrodes of the first sense transistor are connected to the drain and gate electrodes of the power transistor, respectively.

6. The power switch circuit of claim 4, wherein the input terminals of the amplifier circuit are connected to the source electrodes of the power transistor and the first sense transistor, respectively.

7. The power switch circuit of claim 4, wherein the first current source is connected to the source electrode of the first sense transistor.

8. The power switch circuit of claim 4, wherein the source electrode of the second sense transistor is connected to the amplifier circuit, and the drain electrode of the second sense transistor is connected to the gate electrodes of the second sense transistor, the power transistor and the first sense transistor.

9. The power switch circuit of claim 4, wherein the second current source is connected to the drain electrode of the second sense transistor.

10. The power switch circuit of claim 4, wherein the amplifier circuit comprises:
a voltage to current amplifier configured to compare the output voltages of the power transistor and the first sense transistor to generate a corresponding current; and
a current mirror circuit configured to amplify the output current of the voltage to current amplifier.

11. The power switch circuit of claim 10, wherein when the 15 voltage at the source electrode of the power transistor is greater than that at the source electrode of the first sense transistor, the output current of the voltage to the current amplifier is about zero ampere.

12. The power switch circuit of claim 10, wherein when the voltage at the source electrode of the power transistor is lower than that at the source electrode of the first sense transistor, the output current of the voltage to the current amplifier is not zero ampere.

13. The power switch circuit of claim 4, wherein when the resistance of the load circuit is about zero ohm, the first current source is deactivated.

14. The power switch circuit of claim 10, which further comprises a timing circuit, wherein when the period of time during which the output current of the voltage to current amplifier is not zero ampere exceeds a certain time, the timing circuit outputs a signal to deactivate the power transistor.

15. The power switch circuit of claim 14, wherein the timing circuit comprises:
a third sense transistor connected to the current mirror circuit, wherein when the output current of the voltage to current amplifier is not zero ampere, the third sense transistor outputs a current protection signal;
a third current source configured to provide current to the third sense transistor;
a delay timing unit connected to the third sense transistor, wherein when the period of time during which the third sense transistor outputs the current protection signal exceeds a certain time, the delay timing unit outputs a current protection confirmation signal; and
a latch configured to record the output of the delay timing unit.

16. The power switch circuit of claim 14, wherein the timing circuit further comprises:
a fourth sense transistor connected between the third sense transistor and the delay timing unit to enhance the output signal of the third sense transistor, wherein when the period of time during which the fourth sense transistor outputs the current protection signal exceeds a certain time, the delay timing unit outputs a current protection confirmation signal; and
a fourth current source configured to provide current to the fourth sense transistor.

17. A method for limiting the output current of a power switch circuit, the method comprising the steps of:
providing power to a load circuit from a power supply by the power switch circuit;
limiting the output current of the power switch circuit to an over current protection current level if the load circuit is smaller than a threshold; and
limiting the output current of the power switch circuit to a short circuit protection current level if the resistance of the load circuit is substantially equal to zero ohm.

18. The method of claim 17, which further comprises the steps of:
deactivating the power switch circuit if the period of time during which the output current of the power switch circuit is limited to either the over current protection current level or to the short circuit protection current level exceeds a certain time.

19. The method of claim 17, wherein the short circuit protection current level is greater than the over current protection current level.
